(19) United States
(12) Patent Application Publication
(10) Pub. No.: US 2009/0031793 A1
(43) Pub. Date: Feb. 5, 2009

(54) ASSESSMENT OF SURFACE ROUGHNESS OF OBJECTS

(76) Inventors: Philip Koshy, Hamilton (CA); Francois Yacoub, Hamilton (CA)

Correspondence Address: OSTROLENK FABER GERB & SOFFEN, 1180 AVENUE OF THE AMERICAS, NEW YORK, NY, 100368403, US

(21) Appl. No.: 12/281,563

(22) PCT Filed: Feb. 28, 2007
(86) PCT No.: PCT/CA2007/000315

§ 371 Date: Sep. 3, 2008

(30) Foreign Application Priority Data
Mar. 3, 2006 (US) 60778396

(51) Int. Cl. G01B 5/28

(52) U.S. Cl. 73/105

(57) ABSTRACT

A method of assessing the surface roughness of an object includes directing gas supplied at a constant pressure through a control orifice and subsequently to a measurement nozzle adjacent to and spaced from a surface of the object, with subsequent escape of the gas to the atmosphere. The object is moved past the measurement nozzle and the resultant back pressure of the gas upstream of the measurement nozzle and downstream of the control nozzle is measured to provide a back pressure signal. The frequency content of the back pressure signal is examined to thereby obtain an assessment of the surface roughness of the object.

### FIELD OF INVENTION

This invention relates to the assessment of the surface roughness of an object.

### BACKGROUND OF THE INVENTION

It is frequently necessary to assess the surface roughness of an object, which may for example be a machined component. Surface roughness has a critical influence on such characteristics as friction, lubrication, reflectivity, corrosion and fatigue. Optical and mechanical stylus instruments are currently used for this purpose, but such instruments tend to be relatively complex and expensive and not easily integrated with a machine tool.

It is therefore an object of the present invention to provide a method of assessing the surface roughness of an object which is simpler and less expensive than techniques currently used and which is also easily integrated with a machine tool.

### SUMMARY OF THE INVENTION

According to the present invention, the surface roughness of an object is assessed by directing gas supplied at a constant pressure through a control orifice and subsequently through a measurement nozzle adjacent to and spaced from a surface of the object, with subsequent escape of the gas to the atmosphere, moving the object past the measurement nozzle, measuring the resultant backpressure of the gas upstream of the measurement nozzle and downstream of the control orifice to provide a backpressure signal, and examining the frequency content of the backpressure signal to thereby obtain an assessment of the surface roughness of the object.

It has been found that a method of assessing surface roughness of an object in accordance with the invention is simpler and less expensive than known optical/stylus techniques and is also easier to integrate with a machine tool.

The back pressure of the gas upstream of the measurement nozzle and downstream of the control orifice may be sensed by a microphone to provide the back pressure signal. The gas may be supplied at a constant pressure through the control orifice in the range of from about 1 bar to about 4 bar. The measurement nozzle may be spaced from the surface of the object by a distance in the range of from about 0.5 mm to about 2 mm. The measurement nozzle may be spaced A method according to claim 1 wherein the measurement nozzle is spaced from the surface of the object by a distance in the range of from about 50 μm to about 200 μm. The object may be moved past the measurement nozzle at a speed of less than about 500 m/min. The frequency content of the back pressure signal may be correlated to the surface roughness by Wavelet Decomposition, Principal Components and Partial Least Squares analyses.

### DESCRIPTION OF THE DRAWINGS

One embodiment of the invention will now be described, by way of example, with reference to the accompanying drawings, of which:

FIG. 1 is a schematic view of equipment for assessing the surface roughness of an object in accordance with one embodiment of the invention; and

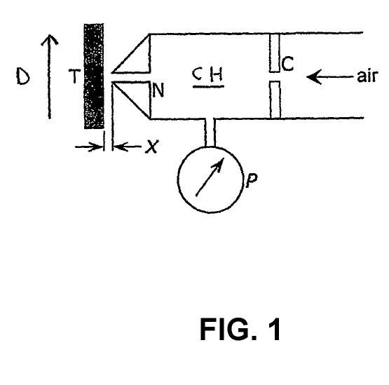

FIG. 2 shows the results of experimental trials.

### DESCRIPTION OF EMBODIMENT

Referring to the drawing, the surface roughness of an object T is assessed by supplying air at constant pressure through a control orifice C into a chamber CH and then through a measurement nozzle N adjacent but spaced from the surface of the object T by a distance X. The object T is moved laterally past the measurement nozzle N in direction D and the backpressure in the chamber CH caused by the surface of the object T is measured by a microphone to provide a backpressure signal P. Appropriate software is provided to examine the frequency content of the backpressure signal P, extract the features of interest and provide an estimated surface roughness. The software may comprise an algorithm which can be used as a classifier based on a pre-specified threshold. The invention is thus especially useful when it is critical to maintain the surface roughness of a machined object below a specified limit. The invention also enables scratches to be detected. Also, the invention is especially suited for use in an in-process manner and thus can be easily integrated with a cutting tool or a machine tool.

Besides its function in assessing surface roughness, the air jet from the measurement nozzle N also cleans the surface of the object, so that surface roughness assessment in accordance with the invention is not prone to cut chips and cutting fluid affecting the assessment as in optical systems.

Frequency information is extracted from the backpressure signal P to create a feature vector. Several techniques such as Fourier Transform, Fast Fourier Transform and Wavelet Analysis can be used to convert the raw signal in the time domain into the frequency domain.

Wavelet Analysis is preferred because it offers a windowing technique with variable-sized regions, with long intervals for more precise low-frequency information and shorter regions for high-frequency information.

Wavelet Analysis also reveals aspects of data such as trends, breakdown points, discontinuities in higher derivatives and self-similarity which other signal analysis techniques cannot do. Further, Wavelet Analysis compresses or de-noises the signal without appreciable degradation.

Multivariate Statistical Analysis is performed on the feature vector to obtain latent variables which characterize the signal. The goal of performing feature reduction is to extract important information from the feature vector. It can be seen as a means to condense the feature vector into a smaller number of features which capture the pertinent information. For this purpose, Multivariate Projection Methods are preferred tools.

A classifier is provided which has a feature vector as the input to output an estimated value of the roughness through regression, achieved through the Partial Least Squares (PLS) technique.

Experimental trials were conducted on a lathe to acquire ten samples each of backpressure signals corresponding to ten different roughness values (Rₐ 1.24 μm to Rₐ 10.3 μm). Each sample was moved laterally past the measurement nozzle at a speed of 100 m/min. The nozzle tip had a diameter of one mm, the supplied pressure was 2 bar and the distance X was 100 μm.

The back pressure signal was analyzed as follows. The frequency information in the time domain microphone signal that corresponds to the surface of interest was first extracted to create a feature vector. Wavelet techniques were used to this end as they offer a variable window size that facilitates processing of both low- and high-frequency components of the signal, while simultaneously providing excellent resolution. Using wavelet analysis, the signal can be decomposed into approximations and details, which refer to the low- and high-frequency components, respectively. The analysis entailed the Daubechies wavelet (See Wavelet Methods for Time Series Analysis, D. B. Percival, A. T. Walden, Cambridge University Press, New York, (2000)). This step was followed by the multivariate statistical technique of Principal Components Analysis (PCA) in order to reduce the dimensionality of the data and to condense the feature vectors into a small number of features that retain the pertinent, useful information (see Introduction to Multi- and Mega-Variate Data Analysis Using Projection Methods, L. Eriksson, E. Johansson, N. K. Wold, S. Wold, Umetrics, Umea (1999)). PCA indicated that the first three principal components accounted for >99% of variation in the data.

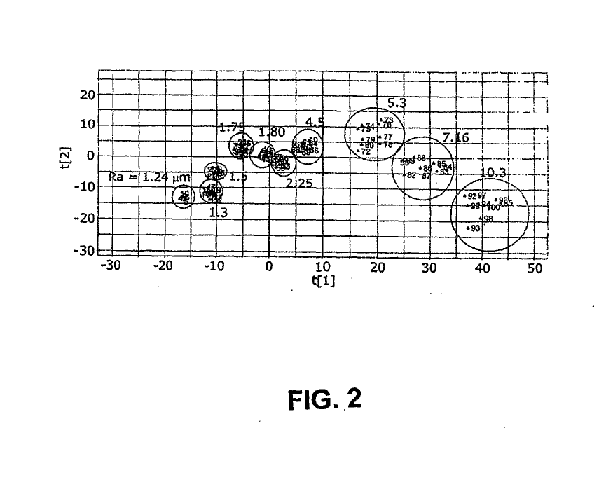

The results of the analysis are shown in FIG. 2 in the latent space [t1] vs. [t2], which indicate that the back pressure signals obtained from the same surface cluster in close proximity, and that the ten different roughness values are well discriminated in respect of the inherent variability in the data. An empirical model was developed using the PLS technique, which is a regression extension of PCA described in Eriksson et al referred to above. The empirical model provided an excellent assessment of the roughness values. The maximum error was 1.4% for the roughness range of Rₐ 1-7 μm.

It will be noted that assessment of surface roughness in accordance with the present invention can be carried out with simple and inexpensive equipment with no moving parts and hence maintenance free. The invention also provides a rapid, non-contact method of assessing surface roughness in real time, independent of work material characteristics, which renders the invention suitable for assessing roughness of surfaces which are fast moving, for example machined components, or are difficult to handle, for example steel being rolled hot. The equipment used is also rugged compared to stylus or optical instruments.

Other advantages and embodiments of the invention will now be readily apparent to a person skilled in the art, the scope of the invention being defined in the appended claims.

1. A method of assessing an object's surface roughness including directing gas supplied at a constant pressure through a control orifice and subsequently to a measurement nozzle adjacent to and spaced from a surface of the object, with subsequent escape of the gas to the atmosphere, moving the object past the measurement nozzle, measuring the resultant back pressure of the gas upstream of the measurement nozzle and downstream of the control nozzle to provide a back pressure signal, and examining the frequency content of the back pressure signal to thereby obtain an assessment of the surface roughness of the object, wherein the back pressure of the gas upstream of the measurement nozzle and downstream of the control orifice is sensed by a microphone to provide the back pressure signal.

2. (canceled)

3. A method according to claim 1 wherein the gas is supplied at a constant pressure through the control orifice in the range of from about 1 bar to about 4 bar.

4. A method according to claim 1 wherein the nozzle has a tip with a diameter in the range of from about 0.5 mm to about 2 mm.

5. A method according to claim 1 wherein the measurement nozzle is spaced from the surface of the object by a distance in the range of from about 50 μm to about 200 μm.

6. A method according to claim 1 wherein the object is moved past the measurement nozzle at a speed of less than about 500 m/min.

7. A method according to claim 1 wherein the frequency content of the back pressure signal is correlated to the surface roughness by Wavelet Decomposition, Principal Components and Partial Least Squares analyses.
